(19) United States
(12) Patent Application Publication
(10) Pub. No.: US 2003/0226311 A1
(43) Pub. Date: Dec. 11, 2003

(54) Creamy candle making compound

(76) Inventor: Claude Roy, Laval (CA)

Correspondence Address: inventarium, #1607, 4050 Rosemont, Montreal, H1X 1M4, CA

(21) Appl. No.: 10/455,061

(22) Filed: Jun. 5, 2003

Related U.S. Application Data
(60) Provisional application No. 60/385,940, filed on Jun. 6, 2002.

(51) Int. Cl. C10L 5/00; C10L 7/00; C11C 5/00

(52) U.S. Cl. 44/275

(57) ABSTRACT

A candle making compound is comprised of a combination of mineral oil, generally liquid paraffin and petrolatum, also known as petroleum gelly.

This application claims priority based on provisional application No. 60/385,940 filed Jun. 6, 2002

### BACKGROUND OF THE INVENTION

1. Field of the Invention

This invention relates to candles and most particularly to candle making kits for consumers.

2. Prior Art

The art of candlemaking has been known for centuries. It basically involves embedding a wick in a mass of combustible material and generating illumination by lighting the wick.

Nowadays, however, candles are used mostly for esthetic reasons rather than for utilitarian reasons, except of course in the event of a power outage wherein candle illumination is still the preferred choice. Because esthetic reasons are a major factor in the selection of candles, a trend has developped towards colored candles or candles having a pleasant, relaxing smell when they burn or even the selection of decorative containers for the candle. Indeed a variety of glass or ceramic containers can be used to hold the combustible substance. After the combustible material has all melted, users are left with a pretty container with nothing to burn. Making new candles out of used containers can be hazardous for the uninitiated since candle wax is made of highly combustible materials that has to be heated at a certain level in order to be poured as a liquid. Heating the candle wax at too high a temperature can result in the wax bursting into an uncontrollable fire.

None of the prior art appears to address the issue of a simple and safe way of making candles by consumers in their own home.

### SUMMARY OF THE INVENTION

This invention proposes a candle making compound and a method for making candles by the end user himself.

It is therefore an object of this invention to provide a simple to use compound that is safe to work with for the end user since it does not require any heating of the compound in the making of candles.

It is another object of this invention to provide for a candle compound that is economical to use.

It is yet another object of this invention to provide for a candle compound that comes in kit form for ease of use by the end user.

It is a final object of this invention to provide for a candle making compound which is easy to manufacture.

In order to achieve this, the candle making compound is comprised of a combination of mineral oil, generally liquid paraffin and petrolatum, also known as petroleum gelly. Commercially available coloring agents and scents can be added to create a family of products.

The foregoing and other objects, features, and advantages of this invention will become more readily apparent from the following detailed description of a preferred composition, wherein the preferred composition of the invention is shown and described, by way of examples. As will be realized, the invention is capable of other and different compositions, and its several details are capable of modifications in various obvious respects, all without departing from the invention. Accordingly, the description is to be regarded as illustrative in nature, and not as restrictive.

### DESCRIPTION OF PREFERRED EMBODIMENTS

(No drawings)

In the manufacturing stage, a mineral oil is poured into petrolatum which has been brought into a liquid state by heating. Generally, a heat in the range of 40 C. to 90 C. at normal air pressure is sufficient to bring petrolatum into a liquid state. The two substances are admixed by striring gently while keeping the overall temperature within the 40 C. to 90 C. range. The mineral oil should consist of between 5 to 30 percent of the total mix to provide for a creamy consistency to the mixture when it is brought down to an average room temperature. Fragrance and coloring agents can optionally be added in small percentages, about 4%, mostly fragrance, within the mixture during the stirring process which is generally sufficient to provide the desired effect. The fragrance and coloring agents are taken from a variety of commercially available products and their quantities can vary slightly according to the desired effect.

Once the ingredients have all been admixed, the mixture is poured directly into the shipping containers where it is let to cool down to become a creamy, thick candle making compound.

The following examples show some of the numerous variations available within the range possible to make the candle compound.

### EXAMPLE 1

65 litres of petrolatum and 10 litres of mineral oil are admixed at a temperature of 70 C. and 3 litres of fragrance is added to the mixture.

### EXAMPLE 2

55 litres of petroleum jelly and 20 litres of liquid paraffin are admixed at a temperature of 60 C. and 3 litres of fragrance is added to the mixture.

### EXAMPLE 3

55 litres of petrolatum and 20 litres of isoparaffin are admixed at a temperature of 80 C. and 3 litres of fragrance is added to the mixture.

At the end user stage, the end user puts a wick into a chosen receptacle and then gently pours the compound from the shipping container directly into the chosen receptacle until the compound reaches just below the tip of the wick. The candle is ready to be used.

The wick has a base which allows it to stand upright while the compound is being poured, such wicks are commercially available and can be included as part of the “home candle making” kit.

1. A creamy candle compound for making candles manufactured with the following method:
petrolatum and mineral oil admixed at a temperature of between 40 C. and 90 C. to create a mixture;
said mineral oil comprising between 5 to 30 percent of said mixture;
said mixture poured into shipping containers to cool.

2. A creamy candle compound for making candles at home as in claim 1 further comprised of:
fragrance and coloring agents in a proportion of approximately 4% of the total mixture.

3. A creamy candle compound for making candles at home as in claim 1 wheras the said mineral oil consists of isoparaffin.

4. A creamy candle compound for making candles having the following method of use:
a wick is put into a receptacle, said mixture poured from said shipping container directly into said receptacle until said mixture reaches just below the tip of said wick.
